(19) United States
(12) Patent Application Publication
(10) Pub. No.: US 2016/0225218 A1
(43) Pub. Date: Aug. 4, 2016

(54) ITEM DISPENSERS

(71) Applicant: STANLEY BLACK & DECKER, INC., New Britain, CT (US)

(72) Inventor: Lawrence Harper, Marietta, GA (US)

(21) Appl. No.: 15/026,056

(22) PCT Filed: Oct. 6, 2014
(86) PCT No.: PCT/US14/59251

§ 371 Date: Mar. 30, 2016

Related U.S. Application Data
(60) Provisional application No. 61/886,919, filed on Oct. 4, 2013.

(51) Int. Cl. G07F 11/50; G07F 9/00

(52) U.S. Cl. CPC G07F 11/50; G07F 9/00

(57) ABSTRACT

An item dispensing system comprises a cabinet and a plurality of dispensing modules selectively installed in the cabinet. The plurality of dispensing modules include a carousel-type dispensing unit and a helical-type dispensing unit.

### DETAILED DESCRIPTION

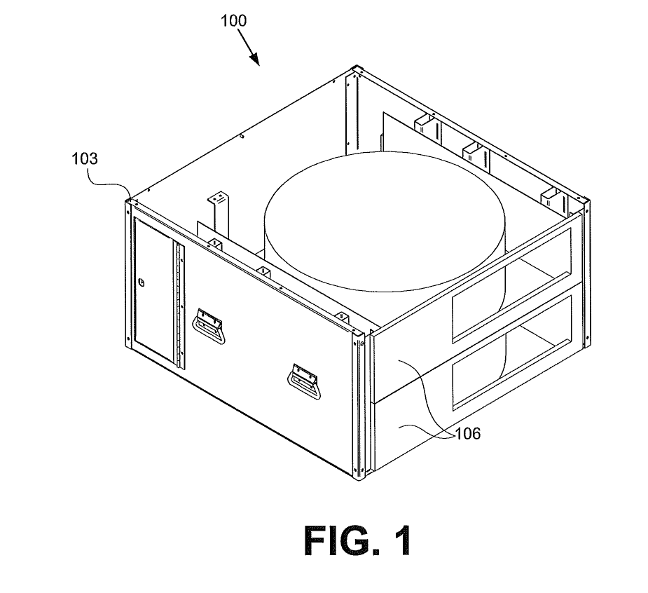

The present disclosure is directed towards item dispensers. With reference to FIG. 1, shown is a portion of an item dispensing assembly 100 according to various embodiments of the present disclosure. The item dispensing assembly 100 may be used to store and dispense items (not shown). In some embodiments, the items stored and dispensed by the item dispensing assembly 100 may include Maintenance, Repair, and Operations (MRO) items. Such items may include, but are not limited to, tools (e.g., power tools, hand tools, etc.), tool accessories (e.g., blades, bits, chucks, batteries, etc.), cleaning supplies, and/or any other type of item that can be used to maintain or repair a device.

The item dispensing assembly 100 in various embodiments may comprise a cabinet 103, one or more item dispensing units 106, and/or other components. As will be discussed in more detail below, one or more items may be stored in each of the item dispensing units 106. The item dispensing units 106 shown in FIG. 1 are embodied as carousel-type item dispensing units 106. In alternative embodiments, alternative types of item dispensing units 106 may be used. As a non-limiting example, multiple helical-type item dispensing units 106 may be installed in the cabinet 103. In some embodiments, multiple types of item dispensing units 106 may be installed. As a non-limiting example, at least one of the item dispensing units 106 may be a helical-type item dispensing unit 106, and at least one of the item dispensing units 106 may be a carousel-type item dispensing unit 106.

As shown in FIG. 1, the item dispensing units 106 are attached to the cabinet 103. The cabinet 103 may contain and provide structural support for the item dispensing units 106. Although two item dispensing units 106 are shown installed in the cabinet 103, one or more item dispensing units 106 may be installed in the cabinet 103 according to various embodiments. As will be described in more detail below, an item dispensing unit 106 in some embodiments may be configured to slide in and out of the cabinet 103 to facilitate stocking the item dispensing unit 106 with items.

One or more of the cabinets 103 may be positioned on a fixed platform (e.g., a table, desk, floor, etc.), on a portable platform (e.g., a cart, s dolly, etc.), or on any other type of suitable structure. The item dispensing assembly 100 in various embodiments may be modular. In this regard, multiple cabinets 103 having one or more item dispensing units 106 may be positioned in various configurations in order to provide various types of item dispensing systems. For example, multiple cabinets 103 may be stacked vertically. Additionally or alternatively, multiple cabinets 103 may be positioned horizontally with respect to each other.

The item dispensing assembly 100 may be coupled to at least one computing device (not shown) that controls various functionality of the item dispensing assembly 100. For example, a user may operate the computing device to identify himself or herself and to request a particular item that is being stored in the item dispensing assembly 100. Upon the computing device determining that the identified worker is authorized to obtain the item, the computing device may manipulate various components of the item dispensing assembly 100 so that the requested item is dispensed to the user. The computing device may also monitor the inventory of the items that are being stored in and/or have been dispensed by the item dispensing assembly 100. As such, the computing device in various embodiments may be similar to one or more of the computing devices that are described in U.S. Pat. No. 8,002,180, issued on Aug. 23, 2011, which is incorporated by reference herein in its entirety.

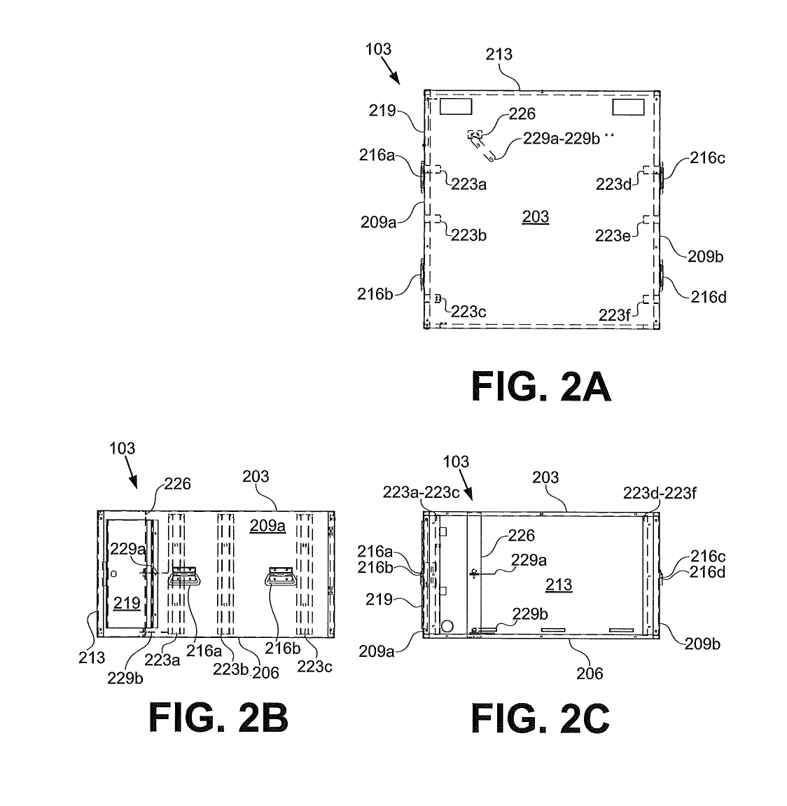

With reference to FIGS. 2A-2C, shown are drawings of an example of the cabinet 103 according to various embodiments. In particular, FIG. 2C shows a front view of the cabinet 103, FIG. 2A shows a top view of the cabinet 103, and FIG. 2B shows a side view of the cabinet 103.

The cabinet 103 in the embodiment shown in FIGS. 2A-2C comprises a top panel 203, a bottom panel 206, side panels 209a-209b, a rear panel 213, and/or other components. Although the top panel 203, the bottom panel 206, the side panels 209a-209b, and the rear panel 213 shown in FIGS. 2A-2C are embodied as separate components, these components may be a portions of a single component in alternative embodiments. Some embodiments of the cabinet 103 may also include one or more drawers that may slide in and out between the side panels 209a-209b.

The cabinet 103 may also include one or more handles 216a-216d. The handles 216a-216d may facilitate a user carrying and moving the cabinet 103 and one or more item dispensing units 106 (FIG. 1) that may be installed in the cabinet 103. Additionally or alternatively, straps (not shown) may pass through the handles 216a-216d to fasten the cabinet 103 and one or more item dispensing units 106 to a platform, such as a table, cart, floor, etc. The handles 216a-216d in the embodiment shown in FIGS. 2A-2C are attached to the respective side panels 209a-209b. In alternative embodiments, the handles 216a-216d may be attached to any other suitable portion of the cabinet 103. The cabinet 103 may also include an access door 219. The access door 219 may facilitate a user accessing the interior portion of the cabinet 103. For example, a user may open the access door 219 to facilitate installing or repairing one or more of the item dispensing units 106 in the cabinet 103. For instance, the access door 219 may facilitate a user coupling the item dispensing units 106 to a power supply, a data bus, and/or an electronic device, such as a keypad, touchscreen, or any other type of input or output device that facilitates the operation of the item dispensing units 106.

The cabinet 103 may also include one or more side channels 223a-223f. The side channels 223a-223f may provide structural support for the cabinet 103. In the embodiment shown in FIGS. 2A-2C, the side channels 223a-223f extend from the bottom panel 206 to the top panel 203. Additionally, the item dispensing units 106 may mount to and be supported by the side channels 223a-223f.

The cabinet 103 may also include one or more mounting bars 226. The mounting bar 226 in the embodiment shown in FIGS. 2A-2C extends from the bottom panel 206 to the top panel 203 of the cabinet 103. In various embodiments, one or more mounting brackets 229a-229b may extend from each of the item dispensing units 106 and attach to the mounting bar 226. To this end, the mounting bar 226 may include a slot for each of the mounting brackets 229a-229b. The mounting brackets 229a-229b may be inserted into the respective slots, and a pull pin or other suitable mechanism may be used to retain the mounting brackets 229a-229b in the slots of the mounting bar 226.

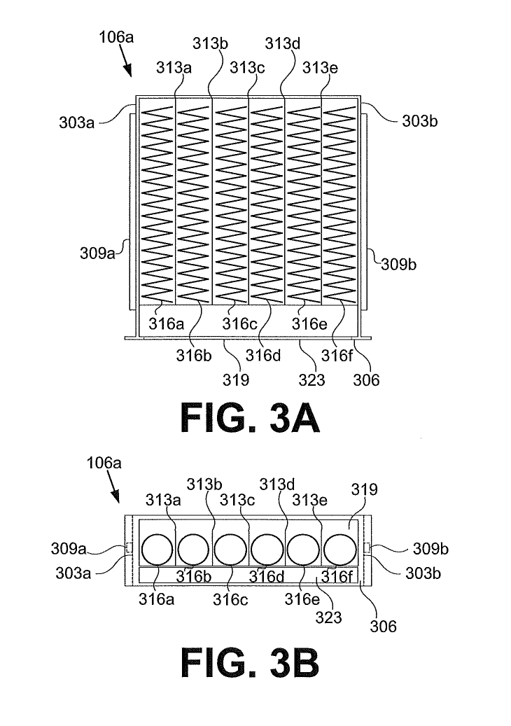

With reference to FIGS. 3A-3B, shown is an example of an item dispensing unit 106, referred to herein as the item dispensing unit 106a, according to various embodiments. In particular, FIG. 3B is a front view of the item dispensing unit 106a, and FIG. 3A is a top view of the item dispensing unit 106a. The item dispensing unit 106a shown in FIGS. 3A-3B is a helical-type item dispensing unit 106a.

The item dispensing unit 106a may comprise side walls 303a-303b, a front wall 306, rails 309a-309b, one or more dividers 313a-313e, one or more helical coils 316a-316f, and/or other components The rails 309a-309b may be attached to the side channels 223a-223f (FIGS. 2A-2C) of the cabinet 103 (FIGS. 2A-2C) to mount the item dispensing unit 106a to the cabinet 103. In some embodiments, the rails 309a-309b are configured to slide with respect to the side walls 303a-303b.

Thus, when the rails 309a-309b are mounted to the side channels 223a-223f of the cabinet 103, the side walls 303a-303b, in conjunction with the front wall 306, the dividers 313a-313e, and helical coils 316a-316f, may slide in and out of the cabinet 103. In some embodiments, the rails 309a-309b may also be configured to pivot with respect to the side walls 303a-303b. Thus, the side walls 303a-303b, in conjunction with the front wall 306, the dividers 313a-313e, and helical coils 316a-316f, may be slid out of the cabinet 103 and be pivoted downward with respect to the cabinet 103 to facilitate a user stocking the item dispensing unit 106a with items.

The helical coils 316a-316f may be used to store and dispense various items. For example, an item may be inserted into a segment of the length of the helical coil 316a, and the helical coil 316a may be rotated about its longitudinal axis to advance the item along the helical coil 316a towards the front wall 306. Upon the item reaching the end of the helical coil 316a that is proximate to the front wall 306, the item may fall to the bottom of the item dispensing unit 106a. The quantity and sizes of the helical coils 316a-316f may vary according to various embodiments of the item dispensing unit 106a. As a non-limiting example, ten helical coils 316a-316f may be installed in the item dispensing unit 106a. The dividers 313a-313e may be positioned between respective ones of the helical coils 316a-316f to separate the items and the helical coils 316a-316f.

The front wall 306 of the item dispensing unit 106a may comprise a window 319, a door 323, and/or potentially other components. The window 319 may be transparent to light to facilitate a user seeing the various items that are stored in the item dispensing unit 106a. The door 323 may be hinged, for example, to facilitate a user reaching through the front wall 306 in order to obtain an item after it has fallen to the floor of the item dispensing unit 106a.

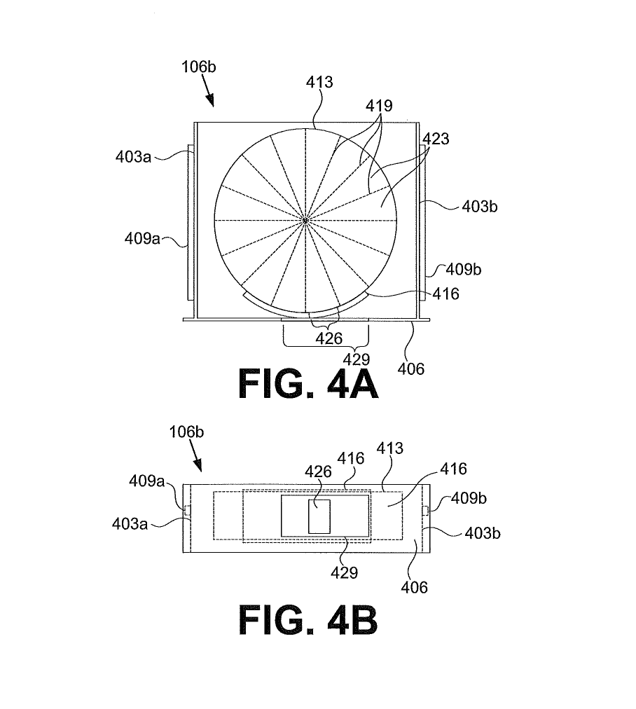

With reference to FIGS. 4A-4B, shown is another example of an item dispensing unit 106, referred to herein as the item dispensing unit 106b, according to various embodiments. In particular, FIG. 4B is a front view of the item dispensing unit 106b, and FIG. 4A is a top view of the item dispensing unit 106b. The item dispensing unit 106b shown in FIGS. 4A-4B is a carousel-type item dispensing unit 106b.

The item dispensing unit 106b may include side walls 403a-403b, a front wall 406, rails 409a-409b, a carousel 413, a carousel bin cover 416, and/or potentially other components. The rails 409a-409b may be attached to the side channels 223a-223f (FIGS. 2A-2C) of the cabinet 103 (FIGS. 2A-2C) to mount the item dispensing unit 106b to the cabinet 103. In some embodiments, the rails 409a-409b are configured to slide with respect to the side walls 403a-403b. Thus, when the rails 409a-409b are mounted to the side channels 223a-223f of the cabinet 103, the side walls 403a-403b, in conjunction with the front wall 406, the carousel 413, and the carousel bin cover 416, may slide in and out of the cabinet 103.

The carousel 413 is configured to store and dispense one or more items. To this end, the carousel 413 may have multiple dividers 419 that form bins 423 in the carousel 413. It is noted that only a subset of the dividers 419 and the bins 423 are labeled in FIGS. 4A-4B for the purpose of clarity. The ends of the bins 423 that are proximate to the circumference of the carousel 413 are open, so that items may be inserted into and removed from the bins 423.

The carousel bin cover 416 may be a component that is configured to cover at least a portion of at least a subset of the bins 423. Additionally, the carousel bin cover 416 may have a port 426 that facilitates a user accessing a particular one of the bins 423. Thus, the carousel 413 may be rotated with respect to the carousel bin cover 416 so that a particular one of the bins 423 is aligned with the port 426. Thereafter, a user may reach into the particular bin 423 and remove one or more items from the particular bin 423.

The front wall 406 of the item dispensing unit 106b may include an opening 429. The opening 429 in the front wall 406 may facilitate a user reaching through the front wall 406 to remove one or more items from one or more bins 423 in the carousel 413.

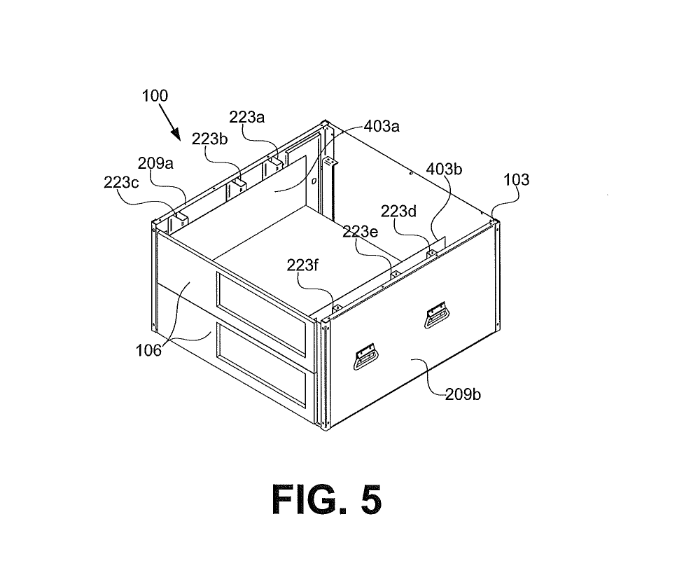

With reference to FIG. 5, shown is a portion of an example of the item dispensing assembly 100 according to various embodiments. In the embodiment shown in FIG. 5, portions of the item dispensing assembly 100 are not shown in order to facilitate a discussion of the installation of the item dispensing units 106 in the cabinet 103. Although two carousel-type item dispensing units 106b are shown installed in the cabinet 103, it is understood that various types and various quantities of item dispensing units 106 may be installed in the cabinet 103 in alternative embodiments. For example, two helical-type item dispensing units 106a may be installed in the cabinet 103, one helical-type item dispensing unit 106a and one carousel-type unit 106b may be installed in the cabinet 103, and/or any other combination of one or more types of item dispensing units 106 may be installed in the cabinet 103 in various embodiments.

As shown in FIG. 5, one item dispensing unit 106b may be positioned in a top portion of the cabinet 103, and another item dispensing unit 106b may be positioned in a bottom portion of the cabinet 103. The rails 409a-409b (FIG. 4) of the respective item dispensing units 106 may be fastened to the side channels 223a-223f of the cabinet 103. Furthermore, the top item dispensing unit 106 may be attached to the mounting bracket 229a (FIGS. 2A-2C), and the bottom item dispensing unit 106 may be attached to the mounting bracket 229b. Thus, the item dispensing units 106 may be fastened to the cabinet 103.

Thereafter, multiple cabinets 103 with multiple item dispensing units 106 may be arranged in various configurations. For example, multiple cabinets 103 may be stacked vertically, and/or multiple cabinets 103 may be positioned horizontally with respect to each other. Additionally, various types of mechanisms may be used to attach multiple cabinets 103 together. For instance, if a first cabinet 103 is positioned on top of a second cabinet 103, a bracket may be fastened to the first cabinet 103 and the second cabinet 103. Such a bracket may be an “L” bracket that is fastened along the vertical edge between one of the side panels 209a-209b and the rear panel 213 or between one of the side panels 209a-209b and the front of the cabinet 103. Thus, multiple cabinets 103 may be attached to each other.

It is emphasized that the above-described embodiments of the present disclosure are merely possible examples of implementations to set forth for a clear understanding of the principles of the disclosure. Many variations and modifications may be made to the above-described embodiments) without departing substantially from the spirit and principles of the disclosure.

What is claimed is:

1. An item dispensing system comprising:
a cabinet; and
a plurality of dispensing units installed in the cabinet, the plurality of dispensing units including at least one carousel-type dispensing unit and at least one helical-type dispensing unit.

2. An item dispensing system comprising:
a cabinet; and
a plurality of dispensing modules selectively installed in the cabinet, the plurality of dispensing modules including one of a carousel-type dispensing unit and a helical-type dispensing unit.

3. The item dispensing system of claim 2 wherein the plurality of dispensing modules are stacked vertically in the cabinet.

4. The item dispensing system of claim 2 wherein the plurality of dispensing modules are stacked horizontally in the cabinet.

5. The item dispensing system of claim 2 wherein a first portion of the plurality of dispensing modules are selectively stacked vertically and a second portion of the plurality of dispensing modules are selectively stacked horizontally in the cabinet.

6. A modular vending system comprising:
a plurality of item dispensing cabinets, each item dispensing cabinet containing a plurality of dispensing modules;
a computing device coupled to a first of the plurality of item dispensing cabinets, the remaining item dispensing cabinets of the plurality of item dispensing cabinets being controlled by the computing device.

7. The modular vending system of claim 6 wherein a plurality of dispensing modules are selectively installed in the plurality of item dispensing cabinets, the plurality of dispensing modules including one of a carousel-type dispensing module and a helical-type dispensing module.
